(19) United States
(12) Patent Application Publication
(10) Pub. No.: US 2025/0020848 A1
(43) Pub. Date: Jan. 16, 2025

(54) LIGHT GUIDE PLATE AND DISPLAY DEVICE

(71) Applicant: E Ink Holdings Inc., HSINCHU (TW)

(72) Inventors: Chun-Chiang LIANG, HSINCHU (TW); Chia Feng HO, HSINCHU (TW); Jen-Yuan CHI, HSINCHU (TW); Yu-Nan PAO, HSINCHU (TW)

(21) Appl. No.: 18/760,024

(22) Filed: Jul. 1, 2024

Related U.S. Application Data
(60) Provisional application No. 63/512,664, filed on Jul. 10, 2023.

(51) Int. Cl. F21V 8/00

(52) U.S. Cl. CPC G02B 6/0016; G02B 6/0053; G02B 6/0088; G02B 6/0091

(57) ABSTRACT

A display device includes a reflective display panel, a light guide plate, a light source, and a first optical adhesive layer. The light guide plate is located on the reflective display device. The light guide plate has a top surface, a bottom surface and a light incident surface connecting the top surface and the bottom surface. The light guide plate further includes multiple microstructures located on the top surface and multiple lenticular structures located on the bottom surface. The light source faces the light incident surface of the light guide plate. The first optical adhesive layer is located below the light guide plate and in contact with the lenticular structure. A refractive index of the first optical adhesive layer is lower than a refractive index of the light guide plate.

### CROSS-REFERENCE TO RELATED APPLICATION

This application claims priority to U.S. Provisional Application Ser. No. 63/512,664, filed Jul. 10, 2023, which is herein incorporated by reference in its entirety.

### BACKGROUND

### Field of Invention

The present invention relates to a light guide plate and a display device.

### Description of Related Art

In a display device equipped with a reflective display panel, microstructures can be formed on the top surface of the light guide plate to increase the light guide effect and improve the color saturation of the display device. However, such design will make the reflected light generated when the light passes through the multi-layer material interface to form stripe patterns on the display screen in the dark state, which may cause degradation of the display quality.

Accordingly, it is still a goal of research and development in this field to provide a display device that can solve the problems above.

### SUMMARY

The invention provides a display device.

In one embodiment, the display device includes a reflective display panel, a light guide plate located on the reflective display panel, a light source facing the light incident surface of the light guide plate, and a first optical adhesive layer located below the light guide plate and in contact with the lenticular structures. The light guide plate further includes multiple microstructures located on the top surface and multiple lenticular structures located on the bottom surface. A refractive index of the first optical adhesive layer is lower than a refractive index of the light guide plate.

In one embodiment, the profile of the lenticular structures has semi-cylindrical shapes, triangular prism shapes or semi-elliptic cylindrical shapes.

In one embodiment, adjacent two of the lenticular structures have no gap therebetween.

In one embodiment, the microstructures are asymmetric.

In one embodiment, the light incident surface has a normal direction, the lenticular structures are arranged along a first direction and extend along a second direction, the first direction is perpendicular to the normal direction, and the normal direction is parallel with the second direction.

In one embodiment, the lenticular structures have a central angle in a range from 30 degrees to 50 degrees.

In one embodiment, each one of the lenticular structures has a width and a depth, and an aspect ratio of the depth over the width is in a range from 0.08 to 0.5.

In one embodiment, the lenticular structures protrude from the bottom surface of the light guide plate towards the reflective display panel, and the lenticular structures and the light guide plate are integrally formed.

In one embodiment, the microstructures are recessed from the top surface of the light guide plate towards the bottom surface.

In one embodiment, the microstructures have a first surface close to the light incident surface, the first surface and the top surface of the light guide plate have a first angle therebetween, and the first angle is in a range from 20 degrees to 40 degrees.

In one embodiment, the microstructures have a second surface away from the light incident surface, the second surface and the top surface of the light guide plate have a second angle therebetween, and the second angle is in a range from 60 degrees to 89 degrees.

In one embodiment, the display device further includes a second optical adhesive layer located on the top surface of the light guide plate and in contact with the microstructures, and a refractive index of the second optical adhesive layer is lower than a refractive index of the light guide plate.

The invention provides a light guide plate applied in a reflective display device. The reflective display device includes a reflective display panel, a light source facing the light guide plate, and an optical adhesive layer in contact with a bottom surface of the light guide plate. The light guide plate includes multiple microstructures located on a top surface and multiple lenticular structures located on the bottom surface and arranged along a first direction.

In one embodiment, the microstructures are asymmetric.

In one embodiment, adjacent two of the lenticular structures have no gap therebetween.

In one embodiment, the lenticular structures have a central angle in a range from 30 degrees to 50 degrees.

In one embodiment, each one of the lenticular structures has a width and a depth, and an aspect ratio of the depth over the width is in a range from 0.08 to 0.5.

In one embodiment, the lenticular structures protrude from the bottom surface of the light guide plate towards the reflective display panel, and the lenticular structures and the light guide plate are integrally formed.

In one embodiment, the microstructures are recessed from the top surface of the light guide plate towards the bottom surface.

In the aforementioned embodiments, the present disclosure makes the incident light enter the reflective display panel nearly perpendicularly through the asymmetric microstructures on the top surface of the light guide plate and the lenticular structures on the bottom surface of the light guide plate, while reducing consistency of the traveling direction of the reflected light. The first optical adhesive layer and the second optical adhesive layer which have low refractive index contact the bottom surface and the top surface to form an interface with a refractive index difference, thereby increasing the color saturation of the display device and improving the quality of the display image.

### BRIEF DESCRIPTION OF THE DRAWINGS

The invention can be more fully understood by reading the following detailed description of the embodiment, with reference made to the accompanying drawings as follows:

FIG. 1A is a side view of a display device according to one embodiment of the present disclosure.

FIG. 1B is a partial perspective view of the display device in FIG. 1A.

FIG. 2A is a side view of a display device according to another embodiment of the present disclosure.

FIG. 2B is a partial perspective view of the display device in FIG. 2A.

FIG. 3 is a side view of a light guide plate and the lenticular structures in FIG. 1A.

FIG. 4 is a simulation diagram of a display device without lenticular structures in the dark state.

FIG. 5 is a simulation diagram of a display device according to one embodiment of the present disclosure in the dark state.

FIG. 6 is a simulation diagram of a display figure of a display device in the dark state.

FIG. 7A to FIG. 7C are schematic diagrams of lenticular structures according to various embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

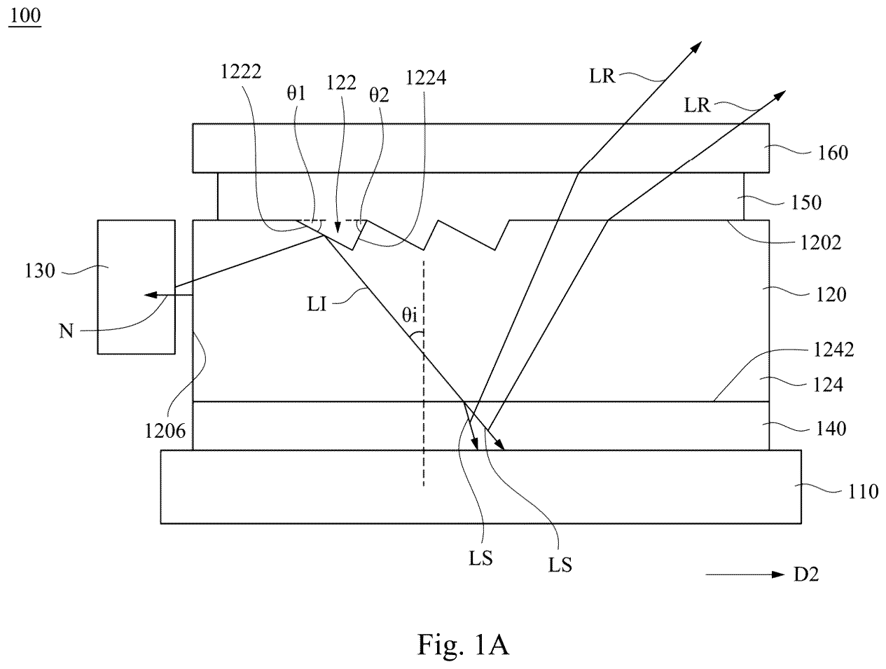

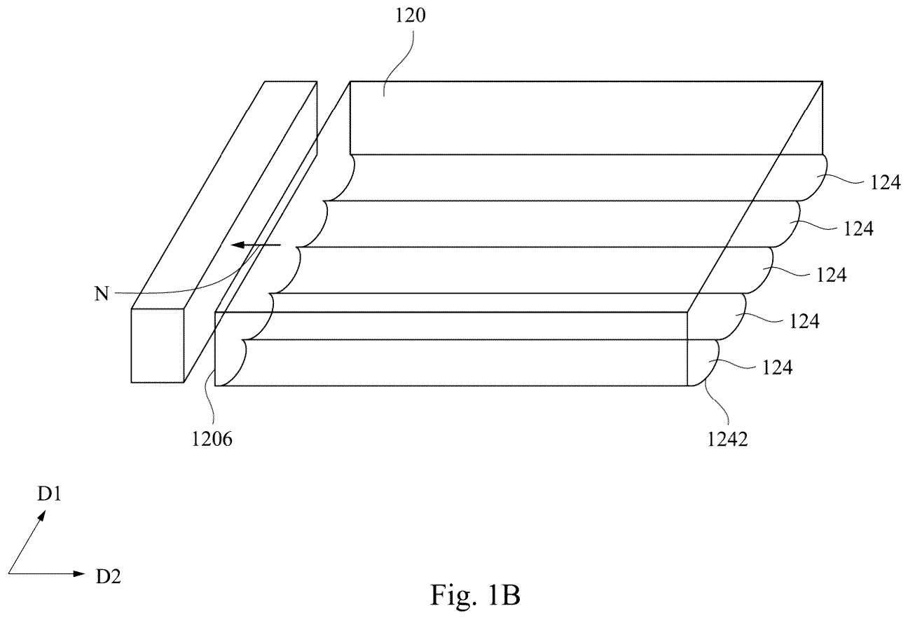

FIG. 1A is a side view of a display device 100 according to one embodiment of the present disclosure. FIG. 1B is a partial perspective view of the display device 100 in FIG. 1A. FIG. 1B only illustrates the light guide plate 120, the lenticular structures 124, and the light source 130. The display device 100 includes a reflective display panel 110, a light guide plate 120 and a light source 130. The light guide plate 120 is located on the reflective display panel 110.

The light guide plate 120 has a top surface 1202, a bottom surface 1242, and a light incident surface 1206 connecting the top surface 1202 and the bottom surface 1242. The top surface 1202 is the surface away from the reflective display panel 110, and the bottom surface 1242 is the surface facing the reflective display panel 110. In the present embodiment, the lenticular structures 124 and the light guide plate 120 are integrally formed. Therefore, the lenticular structures 124 protrude towards the reflective display panel 110, and the bottom surface 1242 of the light guide plate 120 is substantially the bottom surface of the lenticular structures 124.

The light guide plate 120 and the light source 130 form the front light module of the display device 100. The light guide plate 120 further includes multiple microstructures 122 on the top surface 1202 and multiple lenticular structures 124 on the bottom surface 1242. The microstructures 122 are dot-like distributed, and the lenticular structures 124 are arranged regularly. The microstructures 122 are recessed from the top surface 1202 of the light guide plate 120 towards the bottom surface 1242.

The first optical adhesive layer 140 is located on the bottom surface 1242 of the light guide plate 120 and contacts the lenticular structures 124. The refractive index of the first optical adhesive layer 140 is lower than the refractive index of the light guide plate 120. The refractive index of the first optical adhesive layer 140 is less than 1.48.

Reference is made to FIG. 1B. The light source 130 faces the light incident surface 1206 of the light guide plate 120. Specifically, the light source 130 includes multiple light emitting diodes (LEDs) which form a light bar. The light incident surface 1206 of the light guide plate 120 has a normal direction N, and the normal direction N is perpendicular to the first direction D1.

Reference is made to FIG. 1B. The lenticular structures 124 are arranged in the first direction D1. In other words, the arrangement direction of the lenticular structures 124 is the same as the extending direction of the light source 130. The normal direction N of the light guide plate 120 is perpendicular to the arrangement direction of the lenticular structures 124. The lenticular structures 124 extend along the second direction D2, and the normal direction N is parallel to the second direction D2. As an example, a profile of the lenticular structures 124 in the present embodiment has semi-cylindrical shape, but the present disclosure is not limited thereto. In other embodiments, the shape of the profile of the lenticular structures 124 may also include a triangular prism shape or a semi-elliptical cylindrical shape.

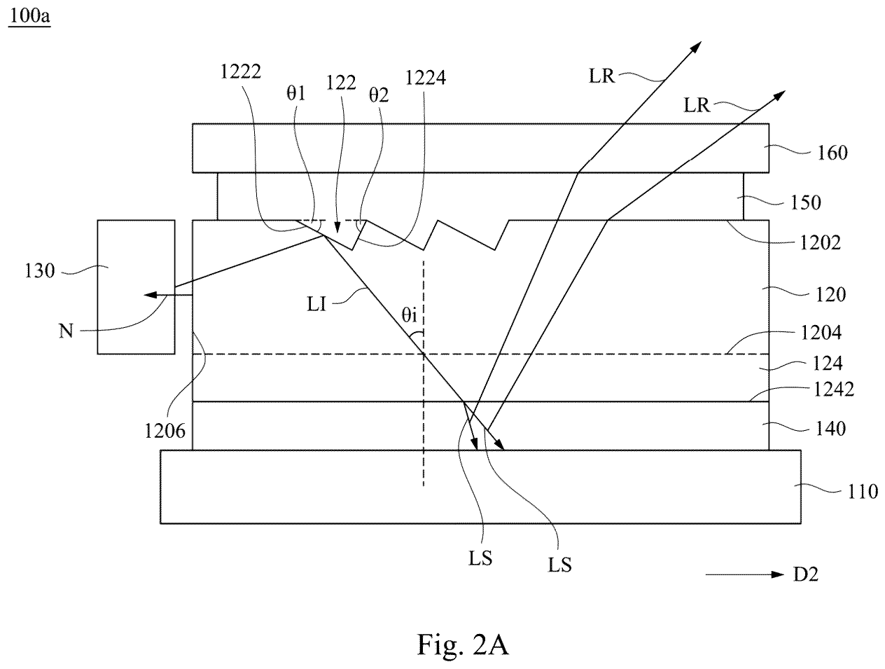

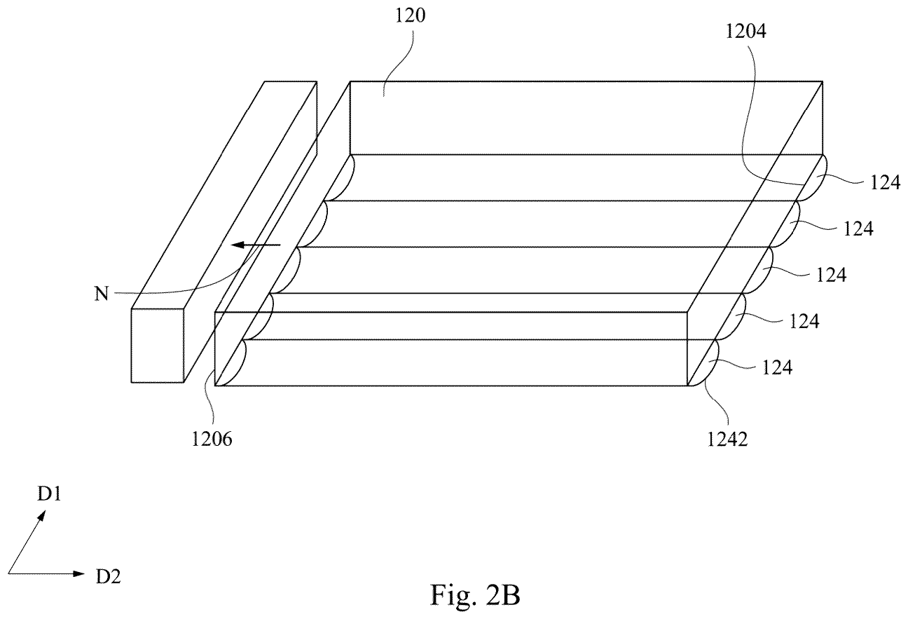

FIG. 2A is a side view of a display device 100a according to another embodiment of the present disclosure. FIG. 2B is a partial perspective view of the display device 100a in FIG. 2A. The display device 100a is similar to the display device 100 in FIGS. 1A and 1B, and the difference is that the lenticular structures 124 of the display device 100a is formed by forming an adhesive layer on the bottom surface 1204 of the light guide plate 120 first and then by imprinting the adhesive layer.

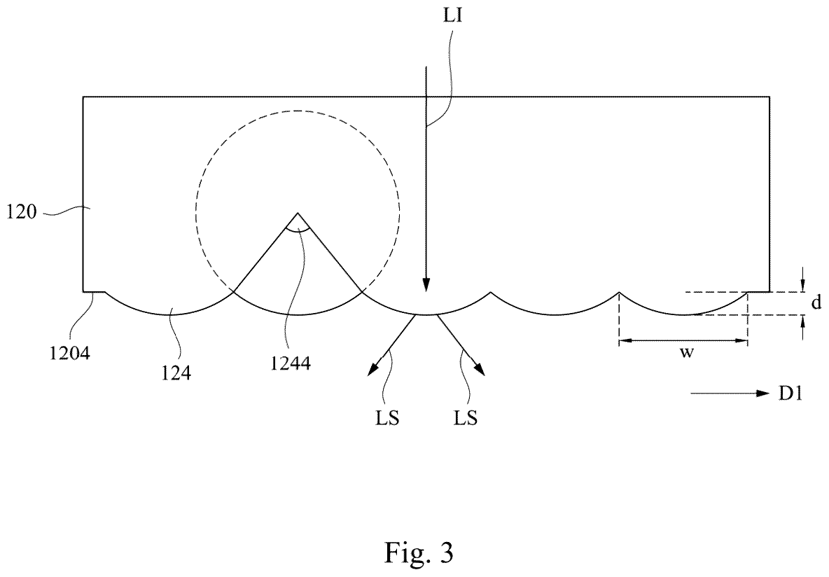

FIG. 3 is a side view of the light guide plate 120 and the lenticular structures 124 in FIG. 1A. The lenticular structures 124 have a central angle 1244, and the central angle 1244 is in a range from 30 degrees to 50 degrees. The lenticular structures 124 have a width w, and the width w is also equivalent to the width of the lenticular structures 124 in the first direction D1. There is no gap between adjacent two of the lenticular structures 124. The lenticular structures 124 have a depth d, which is equivalent to a protruding distance of the lenticular structures 124 towards the reflective display panel 110. The aspect ratio of the depth d over the width w is in a range from 0.08 to 0.5.

Reference is made to FIG. 1A. The microstructures 122 have a first surface 1222 close to the light incident surface 1206 and a second surface 1224 away from the light incident surface 1206. There is a first angle 61 between the first surface 1222 and the top surface 1202 of the light guide plate 120. There is a second angle 62 between the second surface 1224 and the top surface 1202 of the light guide plate 120. The first angle 61 is different from the second angle 82. In other words, the microstructures 122 of the light guide plate 120 are asymmetric. The first angle 61 is in a range from 20 degrees to 40 degrees. The second angle 62 is in a range from 60 degrees to 89 degrees.

Reference is made to FIG. 1A. The display device 100 further includes a second optical adhesive layer 150. The second optical adhesive layer 150 is located on the top surface 1202 of the light guide plate 120 and contacts the microstructures 122. A refractive index of the second optical adhesive layer 150 is lower than the refractive index of the light guide plate 120. The second optical adhesive layer 150 is filled between the first surface 1222 and the second surface 1224 of the microstructures 122. In other words, the medium between the microstructures 122 and the second optical adhesive layer 150 does not contain air or is not vacuum. For example, the refractive index of the light guide plate 120 in the present embodiment is approximately 1.58, and the refractive index of the second optical adhesive layer 150 is less than 1.48, but the disclosure is not limited thereto.

The display device 100 further includes a cover 160. The cover 160 includes an anti-glare layer or a scratch-resistant functional coating. The display device 100 may further include structures such as color filters and touch modules (not shown).

Reference is made to FIG. 1A. The microstructures 122 are configured to reflect the light from the light source 130 to the reflective display panel 110. Through the refractive index difference between the light guide plate 120 and the second optical adhesive layer 150 and the asymmetric design, the angle difference between the incident light L1 and the vertical direction can be reduced. The asymmetric microstructure 122 combined with the second optical adhesive layer 150 having a low refractive index (less than 1.48) allows the incident light L1 to enter the reflective display panel 110 at an incident angle θi, thereby improving color saturation.

In general, when the display device 100 without the lenticular structures 124 is in the dark state, the reflected light (not shown) generated by the incident light L1 passing through the interface between the multi-layer materials will form textures on the display screen, which may cause degradation of the display quality.

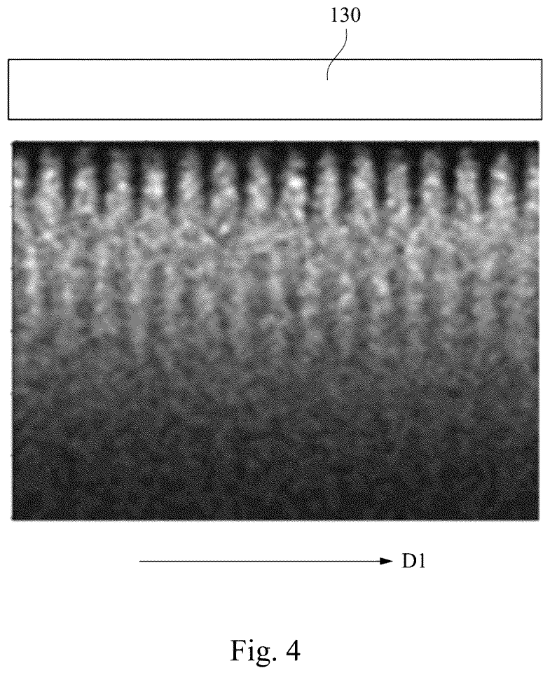

FIG. 4 is a simulation diagram of a display device without lenticular structures 124 in the dark state. When the light guide plate 120 is merely equipped with the microstructures 122 (see FIG. 1A), the consistency of the traveling direction of the incident light L1 increases. The reflected lights show a periodic distribution in the first direction D1, and therefore the reflected lights generate ray-like textures.

Reference is made to FIG. 2A and FIG. 3. When the microstructures 122 of the light guide plate 120 are combined with the lenticular structures 124, the incident light L1 passes through the lenticular structures 124 and forms divergent lights LS traveling in different directions, thus weakening the consistency of the traveling direction of the reflected lights LR. In addition, by combining the lenticular structures 124 with the first optical adhesive layer 140 having a low refractive index (less than 1.48), the reflection efficiency of the reflected lights LR can be improved. Since the lenticular structures 124 occupy the entire bottom surface 1204, the effect of reducing the consistency of the traveling direction of the reflected light LR can be improved.

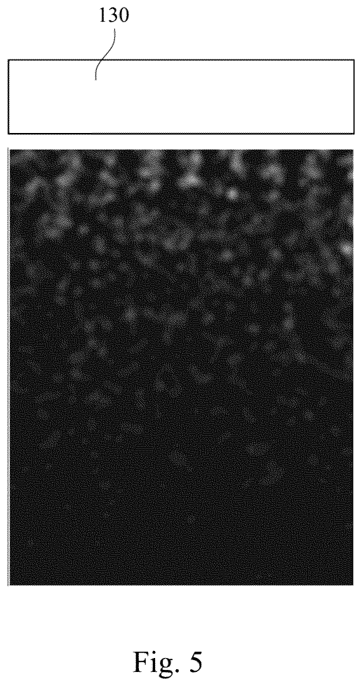

FIG. 5 is a simulation diagram of a display device according to one embodiment of the present disclosure in the dark state. Reference is made to FIG. 3 and FIG. 5 simultaneously. When the light guide plate 120 is equipped with the microstructures 122 and the lenticular structures 124 simultaneously, the ray-like textures generated by the periodic distribution of the reflected lights LR (see FIG. 1A) in the first direction D1 are dispersed. Therefore, when the display device 100 is in the dark state, there is no obvious ray-like textures appear on the display screen, which can improve the display quality. In the present embodiment, the first angle 61 of the microstructures 122 is in a range from 25 degrees to 28 degrees, and the second angle 62 is in a range from 85 degrees to 89 degrees. The central angle 1244 is 40 degrees.

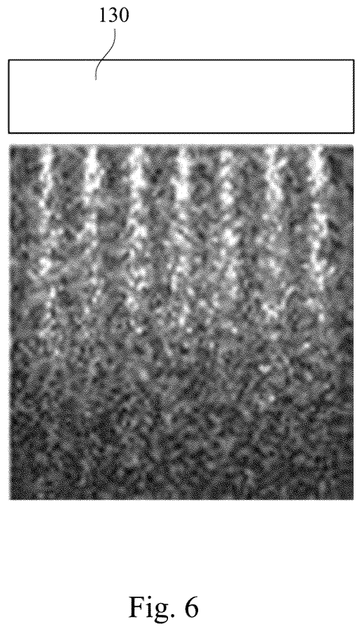

FIG. 6 is a simulation diagram of a display figure of a display device in the dark state. The central angle of the display device in FIG. 6 is greater than 50 degrees. The periodic distribution of reflected light in the first direction D1 results in ray-like textures generated by the reflected lights. It can be seen that when the central angle is too large, it is not beneficial to weaken the consistency of the traveling direction of the reflected light.

Reference is made to FIG. 1A and FIG. 3. According to the aforementioned comparison, it can be seen that the display device of the present disclosure simultaneously increases the color saturation of the display device and improves the display quality in the dark state by disposing asymmetric microstructures 122 and lenticular structures 124 on opposite sides of the light guide plate 120. In addition, when the central angle 1244 of the lenticular structures 124 is in the range from 30 degrees to 50 degrees, the consistency of the traveling direction of the reflected lights can be effectively weakened. It should be noted that the microstructures 122 is utilized to focus light and guide it to the reflective display panel 110, while the lenticular structures 124 is utilized to disperse the light guided through the microstructures 122. In other words, the top surface 1202 of the light guide plate 120 of the display device 100 of the present disclosure is recessed toward the interior of the light guide plate 120, while the bottom surface 1204 protrude toward the outside of the light guide plate 120. In addition, it is necessary to make the first optical adhesive layer 140 and the second optical adhesive layer 150 contact the bottom surface 1204 and the top surface 1202 having low refractive index to form an interface with a refractive index difference, so as to enhance the color saturation and improve the display quality effect in the dark state.

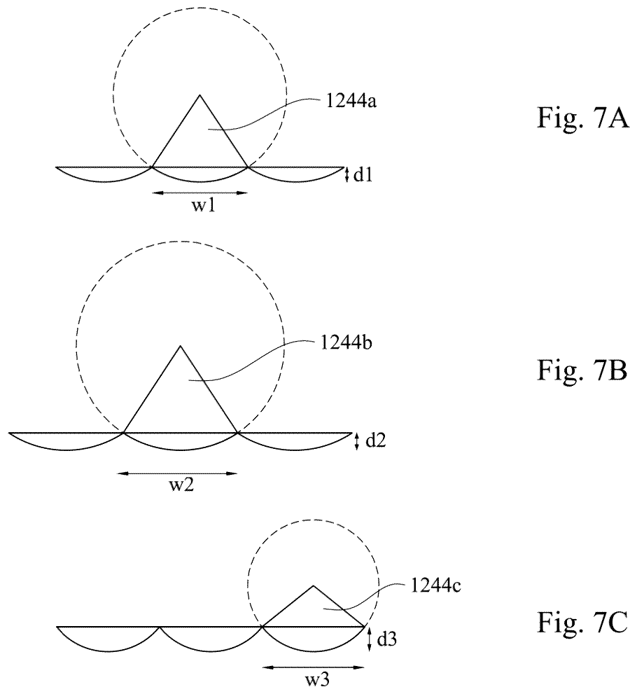

FIG. 7A to FIG. 7C are schematic diagrams of lenticular structures according to various embodiments of the present disclosure. The central angles 1244a, 1244b, and 1244c of the lenticular structures in FIGS. 7A to 7C are 30 degrees, 40 degrees, and 50 degrees, respectively. The lenticular structures in FIGS. 7A to 7C have the light dispersion effect as shown in FIG. 5.

Reference is made to FIG. 7A. The depth d1 of the lenticular structures in the present embodiment is 1.71 microns, the radius of curvature is 50 microns, and the width w1 in the first direction D1 is 25.9 microns. The aspect ratio of the depth d1 over the width w1 is 0.15. Reference is made to FIG. 7B. In the present embodiment, the depth d2 of the lenticular structures is 2.5 microns, the radius of curvature is 42.4 microns, and the width w2 in the first direction D1 is 29 microns. The aspect ratio of the depth d2 over the width w2 is 0.116. Reference is made to FIG. 7C. In the present embodiment, the depth d3 of the lenticular structures is 2.8 microns, the radius of curvature is 30 microns, and the width w3 in the first direction D1 is 25.3 microns. The aspect ratio of the depth d3 over the width w3 is 0.09.

According to the above, lenticular structures with a central angle from 30 degrees to 50 degrees can have the effect of reducing the consistency of the traveling direction of the reflected light through different combinations of width, depth and curvature radius. When the central angle of the lenticular structures is less than 30 degrees or greater than 50 degrees, the light dispersion effect is weak or the light is excessively dispersed, which results in poor improvement in display quality.

In summary, the present disclosure makes the incident light enter the reflective display panel nearly perpendicularly through the asymmetric microstructure on the top surface of the light guide plate and the lenticular structures on the bottom surface of the light guide plate, while reducing the traveling direction of the reflected light. The first optical adhesive layer 140 and the second optical adhesive layer 150 which have low refractive index contact the bottom surface 1204 and the top surface 1202 to form an interface with a refractive index difference, thereby increasing the color saturation of the display device and improving the quality of the display image.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display device, comprising:
a reflective display panel;
a light guide plate located on the reflective display panel, wherein the light guide plate comprises a top surface, a bottom surface, and a light incident surface connecting the top surface and the bottom surface, and the light guide plate further comprises:
a plurality of microstructures located on the top surface; and
a plurality of lenticular structures located on the bottom surface;
a light source facing the light incident surface of the light guide plate; and
a first optical adhesive layer located below the light guide plate and in contact with the lenticular structures, wherein a refractive index of the first optical adhesive layer is lower than a refractive index of the light guide plate.

2. The display device of claim 1, wherein a profile of the lenticular structures has semi-cylindrical shapes, triangular prism shapes or semi-elliptic cylindrical shapes.

3. The display device of claim 1, wherein adjacent two of the lenticular structures have no gap therebetween.

4. The display device of claim 1, wherein the microstructures are asymmetric.

5. The display device of claim 1, wherein the light incident surface has a normal direction, the lenticular structures are arranged along a first direction and extend along a second direction, the first direction is perpendicular to the normal direction, and the normal direction is parallel with the second direction.

6. The display device of claim 1, wherein the lenticular structures have a central angle in a range from 30 degrees to 50 degrees.

7. The display device of claim 1, wherein, each one of the lenticular structures has a width and a depth, and an aspect ratio of the depth over the width is in a range from 0.08 to 0.5.

8. The display device of claim 1, wherein the lenticular structures protrude from the bottom surface of the light guide plate towards the reflective display panel, and the lenticular structures and the light guide plate are integrally formed.

9. The display device of claim 1, wherein the microstructures are recessed from the top surface of the light guide plate towards the bottom surface.

10. The display device of claim 1, wherein the microstructures have a first surface close to the light incident surface, the first surface and the top surface of the light guide plate have a first angle therebetween, and the first angle is in a range from 20 degrees to 40 degrees.

11. The display device of claim 1, wherein the microstructures have a second surface away from the light incident surface, the second surface and the top surface of the light guide plate have a second angle therebetween, and the second angle is in a range from 60 degrees to 89 degrees.

12. The display device of claim 1, further comprising:
a second optical adhesive layer located on the top surface of the light guide plate and in contact with the microstructures, wherein a refractive index of the second optical adhesive layer is lower than a refractive index of the light guide plate.

13. A light guide plate applied in a reflective display device, wherein the reflective display device comprises a reflective display panel, a light source facing the light guide plate, and an optical adhesive layer in contact with a bottom surface of the light guide plate, and characterized in that the light guide plate comprises a plurality of microstructures located on a top surface and a plurality of lenticular structures located on the bottom surface and arranged along a first direction.

14. The light guide plate of claim 13, wherein the microstructures are asymmetric.

15. The light guide plate of claim 13, wherein adjacent two of the lenticular structures have no gap therebetween.

16. The light guide plate of claim 13, wherein the lenticular structures have a central angle in a range from 30 degrees to 50 degrees.

17. The light guide plate of claim 13, wherein each one of the lenticular structures has a width and a depth, and an aspect ratio of the depth over the width is in a range from 0.08 to 0.5.

18. The light guide plate of claim 13, wherein the lenticular structures protrude from the bottom surface of the light guide plate towards the reflective display panel, and the lenticular structures and the light guide plate are integrally formed.

19. The light guide plate of claim 13, wherein the microstructures are recessed from the top surface of the light guide plate towards the bottom surface.
